(19) United States
(12) Patent Application Publication
(10) Pub. No.: US 2008/0028423 A1
(43) Pub. Date: Jan. 31, 2008

(54) DIGITAL BROADCASTING SYSTEM AND METHOD THEREOF

(75) Inventor: Sang-Wook Woo, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/831,493

(22) Filed: Jul. 31, 2007

(30) Foreign Application Priority Data
Jul. 31, 2006 (KR) 2006-72080

(51) Int. Cl. H04N 7/10

(52) U.S. Cl. 725/32

(57) ABSTRACT

A system and a method for providing a digital broadcasting service simultaneously with documented information related to a digital broadcast are provided. The system includes a broadcasting station for transmitting digital broadcast data on each broadcast channel; a data server for storing document information corresponding to the digital broadcast data on each broadcast channel, for searching for requested document information corresponding to prescribed digital broadcasting data, and for transmitting the requested document information; and a digital broadcast receiving apparatus for requesting the data server to transmit the document information corresponding to the digital broadcast data received from the broadcasting station, and for outputting the corresponding document information simultaneously with the digital broadcast data if the corresponding document information is received from the data server in reply to a request. Advantageously, the user can conveniently view with a data service the documented information (i.e., material for a place or an event related to broadcast) pertinent to the digital broadcast program while viewing the digital broadcast.

### PRIORITY

This application claims the benefit under 35 U.S.C. § 119(a) of a Korean Patent Application filed in the Korean Industrial Property Office on Jul. 31, 2006 and assigned Serial No. 2006-72080, the contents of which are incorporated herein by reference.

### BACKGROUND OF THE INVENTION

1. Field of the Invention

The present invention relates to a system and a method for providing a digital broadcasting service, and in particular, to a system and a method for providing users with the digital broadcasting service simultaneously with documented information related to the digital broadcasting.

2. Description of the Related Art

Generally, digital broadcasting refers to such a broadcasting service that provides users with high definition pictures, high sound quality, and a high-end service in place of conventional analog broadcasting. Digital broadcasting is also classified into satellite digital broadcasting and terrestrial digital broadcasting.

The satellite digital broadcasting offers the users a mobile service as its main purpose, and it enables them, anytime and anywhere, to receive multi-channel multimedia broadcasting through portable receivers such as portable phones, personal digital assistants, etc.

The terrestrial digital broadcasting based on Digital Audio Broadcasting (DAB) sends multimedia broadcasting over the air for mobile reception on channel 12 of the VHF band, which is not currently used for any other function, and designates such broadcasting that compositely transmits television broadcasting, radio broadcasting, and data broadcasting through multiple channels.

Recently, there has been increasing interest in a digital broadcasting service which enables the users to receive a digital broadcasting using traditional mobile communications systems. Specifically, there has been increased interest in implementing Digital Multimedia Broadcasting (DMB) services using mobile communication terminals.

Normally, when a user of a terminal (i.e., a digital broadcast receiving apparatus) is receiving a digital broadcast (e.g., movie) and is interested in receiving additional historical background information about a place or an event as seen in the broadcast, they must conduct a separate search for documented materials related to the digital broadcast. Typically, these supplemental searches are conducted via the Internet and can often be tedious and time-consuming.

Here, users of digital broadcasting terminals could greatly enhance their learning if they could tune into educational or linguistic broadcasting while, simultaneously, referring to separate learning material. However, for this to occur, users must first purchase this learning material at a bookstore, for example, before tuning into the educational or the linguistic broadcast itself on their digital broadcast terminals.

It is seldom convenient for the users to prepare and view the additional learning materials corresponding with the educational or the linguistic broadcast, and to continually check the prepared learning materials while viewing the educational or the linguistic broadcast.

### SUMMARY OF THE INVENTION

An aspect of the present invention is to substantially solve at least the above problems and/or disadvantages and to provide at least the advantages below. Accordingly, an aspect of the present invention is to provide a system and a method for providing users of mobile terminals with a digital broadcasting service simultaneously with document information related to the digital broadcast.

Another aspect of the present invention is to provide a system and a method for energizing the usage of a data service in digital broadcasting.

According to one aspect of the present invention, there is provided a digital broadcasting system that includes a broadcasting station for transmitting digital broadcasting data on each broadcast channel; a data server for storing document information corresponding to the digital broadcasting data on each broadcast channel, for searching for requested document information if there exists a request for the document information corresponding to prescribed digital broadcasting data, and for transmitting the requested document information; and a digital broadcast receiving apparatus for requesting the data server to transmit the document information corresponding to the digital broadcasting data received from the broadcasting station, and for outputting the corresponding document information simultaneously with the digital broadcasting data if the corresponding document information is received from the data server in reply to the request.

According to another aspect of the present invention, there is provided an apparatus for receiving a digital broadcast that includes a digital broadcast receiving unit for receiving digital broadcast data on a broadcast channel requested by a user; a wireless transmitting-receiving unit for requesting a data server to transmit document information corresponding to the digital broadcasting data, and for receiving the requested document information, wherein the data server stores document information corresponding to a broadcast program on each broadcast channel; an output unit for outputting the received document information simultaneously with the digital broadcasting data if the requested document information is received by the wireless transmitting-receiving unit; and a control unit for controlling an overall operation of the apparatus for receiving a digital broadcast.

According to another aspect of the present invention, there is provided a method for providing a digital broadcasting service in a digital broadcast receiving apparatus according to an embodiment of the present invention. The method includes receiving digital broadcasting data on a broadcast channel requested by a user; requesting a data server to transmit document information corresponding to the digital broadcasting data, wherein the data server stores document information corresponding to a broadcast program of each broadcast channel; and outputting the received document information simultaneously with the digital broadcasting data if the requested document information is received from the data server.

### BRIEF DESCRIPTION OF THE DRAWINGS

The above and other objects, features, and advantages of the present invention will be more apparent from the following detailed description taken in conjunction with the accompanying drawings, in which:

FIG. 1 is a schematic view illustrating a configuration of a system for providing a digital broadcasting service according to a preferred embodiment of the present invention;

FIG. 2 is a schematic diagram illustrating a data server of a digital broadcasting system according to a preferred embodiment of the present invention;

FIG. 3 is a schematic diagram illustrating a digital broadcast receiving apparatus of a digital broadcasting system according to a preferred embodiment of the present invention;

FIG. 4 is a flow diagram illustrating a procedure of a method for providing a digital broadcasting service in a digital broadcasting system according to a first preferred embodiment of the present invention;

FIG. 5 is a flow diagram illustrating a procedure of a method for providing a digital broadcasting service in a digital broadcasting system according to a second preferred embodiment of the present invention; and

FIG. 6 is a view illustrating an example of an operation of a digital broadcast receiving apparatus of a digital broadcasting system according to a preferred embodiment of the present invention.

### DETAILED DESCRIPTION OF THE PREFERRED EMBODIMENT

Hereinafter, preferred embodiments of the present invention will be described with reference to the accompanying drawings. The same elements will be designated by the same reference numerals all through the following description and drawings although they are shown in different drawings. Further, in the following description of the present invention, a detailed description of known functions and configurations incorporated herein will be omitted when it may make the subject matter of the present invention rather unclear.

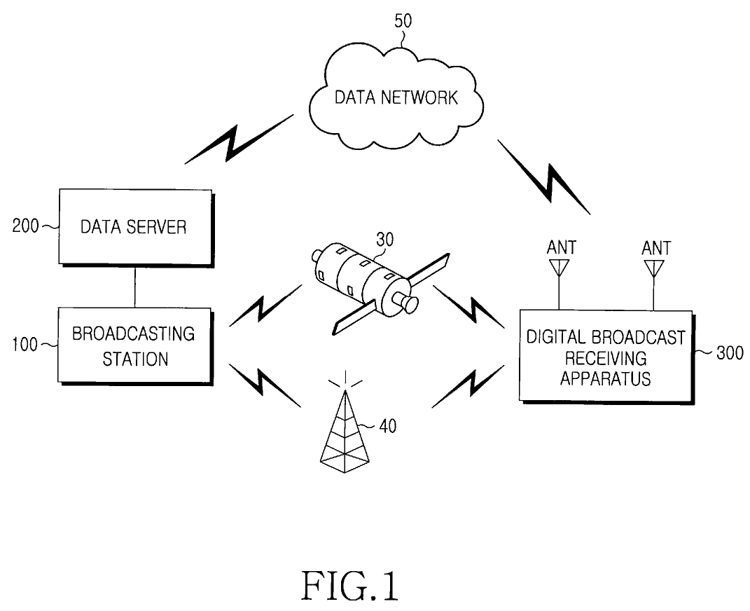

FIG. 1 is a schematic view illustrating a configuration of a system for providing a digital broadcasting service according to a preferred embodiment of the present invention.

As illustrated in FIG. 1, the system for providing the digital broadcasting service (hereinafter digital broadcasting system) includes a broadcasting station 100, a data server 200, and an apparatus for receiving a digital broadcast 300 (hereinafter digital broadcast receiving apparatus).

The broadcasting station 100 reconfigures digital broadcasting data from multimedia data on each of broadcast channels, and sends the digital broadcasting data over the air through a network. The digital broadcasting data transmitted by the broadcasting station 100 is provided to the digital broadcast receiving apparatus 300 by the medium of a repeater 40 on earth or an artificial satellite 30 (i.e., a transponder is included in the satellite).

The data server 200 stores digital broadcasting data of each broadcast channel, i.e., document information corresponding to a digital broadcast program. In operation, if there exists a request for document information corresponding to prescribed digital broadcasting data, the data server 200 searches for the requested document information, and transmits the document information to the digital broadcast receiving apparatus 300 through a data network 50.

Preferably, the above document information implies document material related to a digital broadcast program. For example, if digital broadcasting corresponds to educational broadcasting or linguistic broadcasting, the document material may be material for a lecture, material for a linguistic learning, etc. Another example may be where the digital broadcast program corresponds to a movie or a drama, the document material may be related to a place or a historical background shown in the movie or drama. When the document information is preserved in a data server 200, it is stored after classifying it according to a Packet IDentifier (PID) of the relevant digital broadcasting data.

The data server 200 receives the document information corresponding to the digital broadcasting data of each broadcast channel from the broadcasting station 100 or from an external apparatus for special use, and is able to store it. Including the data server 200 in the broadcasting station 100 is one of the possible configurations of the digital broadcasting system. On the other hand, it is desirable that the data server 200 delivers the document information at a preset cycle (i.e., every day or every week) to update the already stored document information. It is also possible that the data server 200 receives the document information whenever the document information changes to update the delivered the document information.

On receiving digital broadcasting data from the broadcasting station 100, the digital broadcast receiving apparatus 300 requests the data server 200 to transmit document information corresponding to the digital broadcasting data. When the document information is received from the data server 200 in response to the request, the digital broadcast receiving apparatus 300 outputs the document information simultaneously with the digital broadcasting data.

The data network 50 corresponds to a mobile wireless communication network, and can be one of Code Division Multiple Access (CDMA), Universal Mobile Telecommunications System (UMTS), Global System for Mobile communication (GSM) networks, etc. The data network 50 is equipped with multiple electronic exchangers (not shown) each of which is connected with multiple Base Station controllers (BSCs) each of which is connected with multiple Base Stations (BSs)

Each base station is connected with multiple Mobile Stations (MSs) via a public wave network. Herein, the base station is connected with the mobile station in a scheme of Time Division Multiple Access (TDMA) or CDMA, etc., and can transmit packet data such as Short Message Service (SMS) message, Enhanced Messaging Service (EMS) message, etc. In addition, by the medium of a prescribed gateway, each of the electronic EXchangers (EX) can be not only connected with a Public Switched Telephone Network (PSTN), an Integrated Services Digital Network (ISDN) or other mobile wireless communication networks, but also connected with an internet by the medium of an InterWorking Function (IWF) and of a Wireless Application Protocol (WAP) gateway.

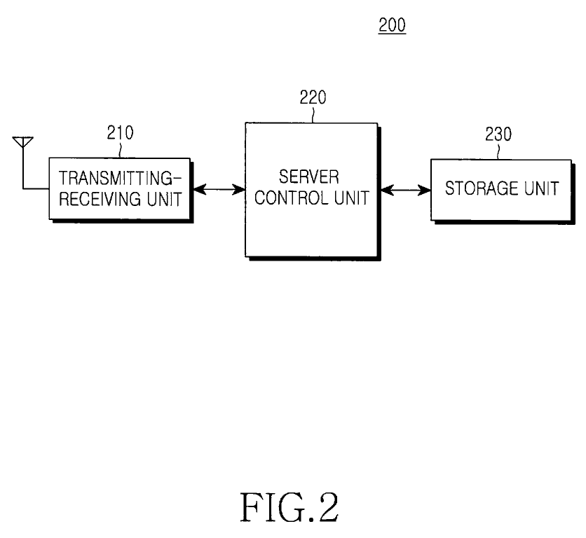

FIG. 2 is a schematic diagram illustrating the data server of the digital broadcasting system according to a preferred embodiment of the present invention.

As illustrated in FIG. 2, the data server 200 includes a transmitting-receiving unit 210, a server control unit 220, and storage unit 230.

With reference to FIGS. 1 and 2, the transmitting-receiving unit 210 receives a message for requesting the document information corresponding to the prescribed digital broadcasting data from the digital broadcast receiving apparatus 300, provides the received message to the server control unit 220, and transmits the requested document information to the digital broadcast receiving apparatus 300 under the control of the server control unit 220. In addition, the transmitting-receiving unit 210 receives the document information corresponding to the digital broadcasting data on each broadcast channel from the broadcasting station 100 or from an external apparatus for special use.

The server control unit 220 controls an overall operation of the data server 200. Moreover, the server control unit 220 receives the document information corresponding to digital broadcasting data of each broadcast channel via the transmitting-receiving unit 210, and stores the received document information. The server control unit 220 controls the document information to be classified according to the PID of the relevant digital broadcasting data and to be stored, which causes all document information to be classified in terms of the digital broadcasting data.

When the transmitting-receiving unit 210 receives a message for requesting the document information corresponding to the digital broadcasting data, the server control unit 220 detects the PID included in the message, and searches the storage unit 230 for the document information having the same PID as above. At this time, when information on broadcasting hours related to the digital broadcasting data of each broadcast channel has been already stored, the server control unit 220 can search for the requested document information even more efficiently by checking the present time on receiving the message for requesting the document information.

If the server control unit 220 has discovered the requested document information in the storage unit 230, the server control unit 220 reads the searched document information, and transmits the read document information to the digital broadcast receiving apparatus 300 via the transmitting-receiving unit 210.

Conversely, if the requested document information does not exists in the storage unit 230, it is desirable that the server control unit 220 transmits a message for reporting the nonexistence of the document information to the digital broadcast receiving apparatus 300.

The storage unit 230 stores all the information required to control the operation of the data server 200 according to a preferred embodiment of the present invention. In addition, under the control of the server control unit 220, the storage unit 230 classifies the document information corresponding to the digital broadcasting data on each broadcast channel according to the PID, and stores the classified document information together with the information on the broadcasting hours of each digital broadcasting data.

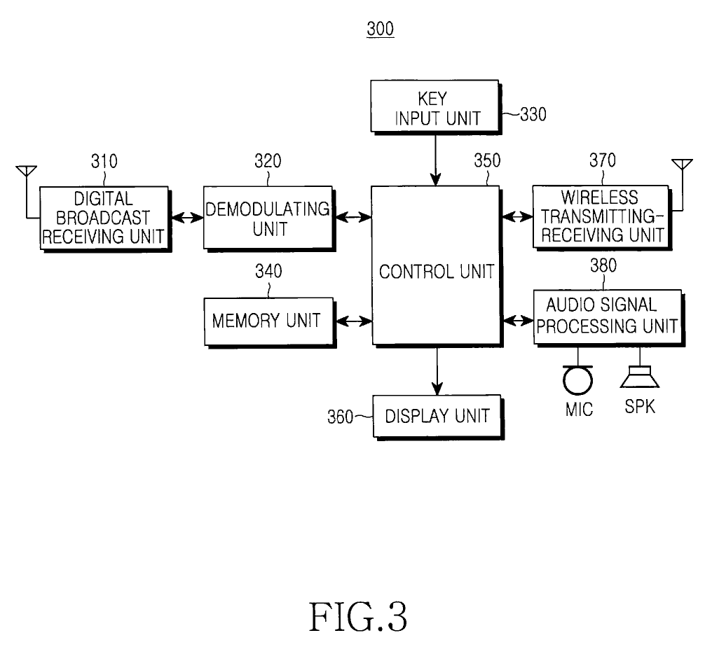

FIG. 3 is a schematic diagram illustrating the digital broadcast receiving apparatus of the digital broadcasting system according to a preferred embodiment of the present invention.

In FIG. 3, the digital broadcast receiving apparatus 300 includes a digital broadcast receiving unit 310, a demodulating unit 320, a key input unit 330, a memory unit 340, a control unit 350, display unit 360, a wireless transmitting-receiving unit 370, and an audio signal processing unit 380. Preferably, the display unit 360 and audio processing unit 380 serve as output units.

The digital broadcast receiving unit 310 receives a digital broadcasting signal (i.e., digital broadcasting data) on a broadcast channel requested by a user, and outputs the received digital broadcasting signal to the demodulating unit 320. The digital broadcasting data designates either video broadcasting outputting a combination of an image and an audio or audio broadcasting outputting only an audio.

The demodulating unit 320 eliminates a carrier wave from the digital broadcasting signal received by the digital broadcast receiving unit 310, demodulates the digital broadcasting signal without the carrier wave into a digital data stream, and provides the digital data stream to the control unit 350.

The key input unit 330 is equipped with character keys, numeric keys, and various kinds of function keys, and provides a key input signal to the control unit 350 in response to a key pressed by the user.

The memory unit 340 stores all the information required to control the operation of the digital broadcast receiving apparatus 300. In addition, the memory unit 340 stores both Electronic Program Guide Data (EPGD) of digital broadcasting received by the digital broadcast receiving unit 310 and an address of the data server 200 storing the document information corresponding to the digital broadcasting data on each broadcast channel according to the PID.

The control unit 350 controls the overall operation of the digital broadcast receiving apparatus 300. In addition, the control unit 350 decodes a digital broadcasting stream provided by the demodulating unit 320, and outputs a decoded digital broadcasting stream to the audio processing unit 380 and to the display unit 360 via an audio signal processing unit (not shown) and a video signal processing unit (not shown).

Moreover, if the digital broadcast receiving unit 310 receives the digital broadcasting data, the control unit 350 checks if the digital broadcast receiving unit 310 has downloaded the document information corresponding to the received digital broadcasting data. Then, the control unit 350 enables the display unit 360 to show a message such as, “Would you like to download the document material?” in order to check if the document information corresponding to the received digital broadcast data is to be downloaded. Consequently, it is also possible to inform the user of the message in the manner of an acoustic output.

Additionally, the control unit 350 may check if the document information is downloaded only if the digital broadcasting data is a program of educational broadcasting. In this case, the control unit 350 scans channel information or the PID of the digital broadcasting data received by the digital broadcast receiving unit 310, and can determine if the digital broadcasting data is a program of educational broadcasting.

When the control unit 350 wants to check with the PID if the digital broadcasting data is a program of educational broadcasting, since the PID is included in the digital broadcasting data, the control unit 350 checks the PID included in the relevant digital broadcasting data, and can determine if the digital broadcasting data is a program of educational broadcasting.

In addition, where the control unit 350 wants to confirm from the channel information if the digital broadcasting data is a program of educational broadcasting, the control unit 350 identifies Service Description Table (SDT) information including information indicating the name of channel, Uniform Source Locator (USL) information on channels, the type of channel, etc. among information configuring the EPGD of the digital broadcasting, which has been stored in the memory unit 340, and determines if the digital broadcasting data is a program of educational broadcasting.

In the meantime, if the document information is requested by the user who checks the download confirming message, the control unit 350 detects the PID of the digital broadcasting data, includes the detected PID in the message requesting the document information, and transmits the message including the detected PID to the data server 200. If a key is pressed by the user who views the message shown by display unit 360, the control unit 350 can judge that it corresponds to a request for the document information, and can request the document information according to an address of the data server 200 stored in memory unit 340.

If the document information is received from the data server 200, the control unit 350 displays the received document information in a prescribed position of an output screen of the digital broadcasting in the scheme of Picture-In-Picture (PIP). At this time, it is desirable that the control unit 350 analyzes a file format of the document information, and that controls a display of the document information in order to be suitably displayed for the relevant format. To satisfy the above requisite, the control unit 350 can be equipped with a file viewer.

When the received digital broadcasting data corresponds to a program of audio broadcasting, since only an audio output is generated from the audio processing unit 380 during the output of broadcasting, the control unit 350 is able to control the display of the document information so as to be displayed on an overall output screen of the digital broadcasting.

Moreover, whenever a predetermined key (e.g., an arrow key) is pressed, the control unit 350 controls the output unit to scroll a current display of the document information on a screen of the output unit, and can show a scrolled display thereof in place of the current display thereof.

Moreover, if the wireless transmitting-receiving unit 370 receives a message reporting the nonexistence of the document information from the data server 200, the control unit 350 outputs the received message to be able to inform the user of the nonexistence of the requested document information.

The display unit 360 provides all the display data produced by the digital broadcast receiving apparatus 300, and comprises a Liquid Crystal Display (LCD), etc., which can effectively display digital broadcasting data. If the LCD includes a touch screen feature, the display unit 360 can be operated as an input unit.

In response to the control unit 350, the wireless transmitting-receiving unit 370 performs a function of transmission-reception of audio data, character data, image data, and control data, and includes a Radio Frequency (RF) transmitter (not shown) which upwardly converts the frequency of a transmission signal, and which amplifies the magnitude thereof, and an RF receiver (not shown) which downwardly converts the frequency of a received signal, and which amplifies the magnitude thereof. Preferably, the wireless transmitting-receiving unit 370 requests the data server 200 store the document information corresponding to the broadcast program of each broadcast channel to transmit the document information corresponding to the digital broadcasting data, and receives the requested document information from the data server 200 so as to provide it to the control unit 350.

The audio processing unit 380 demodulates an electrical signal received from a MICrophone (MIC) to convert it into audio data, and demodulates coded audio data received from the wireless transmitting-receiving unit 370 to an electrical signal to provide the demodulated electrical signal to a SPeaKer (SPK). Furthermore, the audio processing unit 380 is equipped with a Codec which converts digital audio signal received by the wireless transmitting-receiving unit 370 into an analog signal to reproduce the digital audio signal, or which converts an analog audio signal generated from the MIC into a digital audio signal. The Codec includes a data Codec and an audio Codec, which respectively process packet data and audio signal such as a voice, etc., and can be included in the control unit 350.

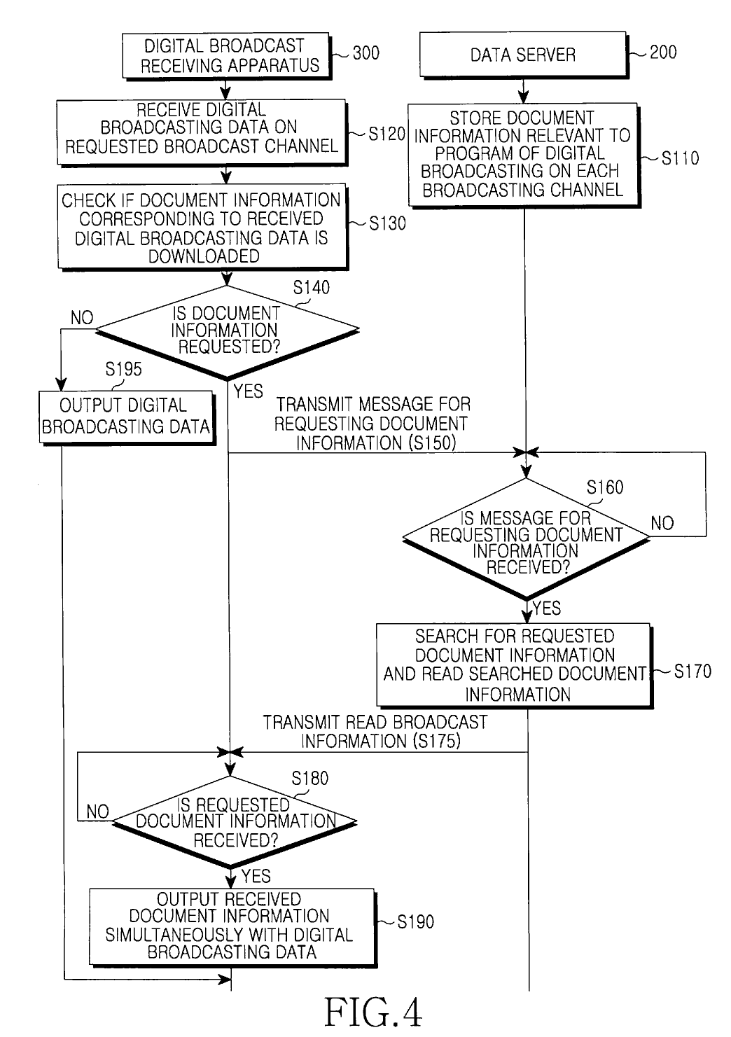

FIG. 4 is a flow diagram illustrating a procedure of a method for providing a digital broadcasting service in a digital broadcasting system according to a first preferred embodiment of the present invention.

In FIGS. 1 to 4, in step 110, the data server 200 stores the document information corresponding to the digital broadcast program of each broadcast channel. The data server 200 receives the document information at every prescribed cycle from the broadcasting station 100 or from the external apparatus for special use, or can receive the document information whenever it changes. For fast searching for the document information, the data server 200 stores the document information after classifying the document information according to the PID of the relevant digital broadcasting data. Moreover, the data server 200 can also store the information on the broadcasting hours of each digital broadcasting data together with the document information. On the other hand, when the same broadcast program is sent over the air in a mutually different time zone, the data server 200 stores the information on the broadcasting hours of each digital broadcasting data together with the document information so as to efficiently search for the document information of the digital program sent over the air at a relevant time.

In step 120, the digital broadcast receiving apparatus 300 receives from the broadcasting station 100 the digital broadcasting data upon broadcast channel requested by the user.

In step 130, the digital broadcast receiving apparatus 300 checks if the digital broadcast receiving apparatus 300 has downloaded the document information corresponding to the received digital broadcasting data. So as to check if the relevant document information is to be downloaded, it is desirable that the digital broadcast receiving apparatus 300 shows a message relevant to the above checking on a screen of the display unit 360.

In step 140, the digital broadcast receiving apparatus 300 checks if there exists a request for the document information. If a key is pressed by the user who views the download confirming message shown by display unit 360, then the digital broadcast receiving apparatus 300 can judge that pressing of the key corresponds to the request for the document information.

In step 195, if there exists no request for the document information, the digital broadcast receiving apparatus 300 outputs the received digital broadcasting data via the output unit.

In step 150, if there exists the request for the document information, then the digital broadcast receiving apparatus 300 generates a message for requesting the document information to transmit the message to data server 200. The message includes the PID of the pertinent digital broadcasting data.

In step 160, the data server 200 checks if any message for requesting the document information is received from the digital broadcast receiving apparatus 300.

In step 170, if the message for requesting the document information is received from the digital broadcast receiving apparatus 300, then the data server 200 searches previously stored document information of each broadcast channel for the requested document information to read the searched document information. For example, the data server 200 detects the PID included in the message, searches for the document information having the same PID as the detected PID, and reads the searched document information.

In step 175, the data server 200 transmits the read document information to the digital broadcast receiving apparatus 300 on data network. On the other hand, if the above search results in the nonexistence of the document information having the same PID as the detected PID, the data server 200 can transmit a message informing the user of the nonexistence of the document information. On receiving the message, the digital broadcast receiving apparatus 300 outputs the message to inform the user of the nonexistence of the requested document information.

In step 180, the digital broadcast receiving apparatus 300 checks if the requested document information is received.

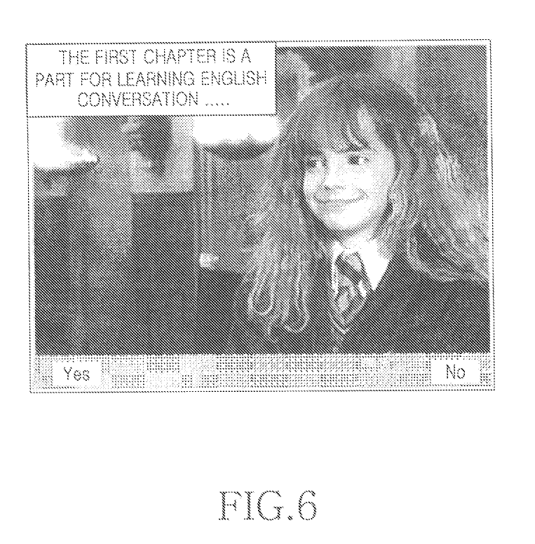

In step 190, if the requested document information is received, the digital broadcast receiving apparatus 300 outputs the received document information along with the digital broadcasting data. Here, the digital broadcast receiving apparatus 300 displays the received document information in a prescribed position on an output screen of digital broadcasting in a Picture-In-Picture (PIP) format, as illustrated in FIG. 6. Whenever a predetermined key (e.g., an upward or a downward arrow key) is pressed, the digital broadcast receiving apparatus 300 controls the output unit to scroll a current display of the document information on a screen of the output unit, and can show a scrolled display thereof in place of the current display thereof.

Where the digital broadcasting data received from the broadcasting station 100 corresponds to a program of audio broadcasting, since the digital broadcast receiving apparatus 300 generates only an audio output without an image output, the digital broadcast receiving apparatus 300 displays the document information on an overall output screen of the digital broadcasting.

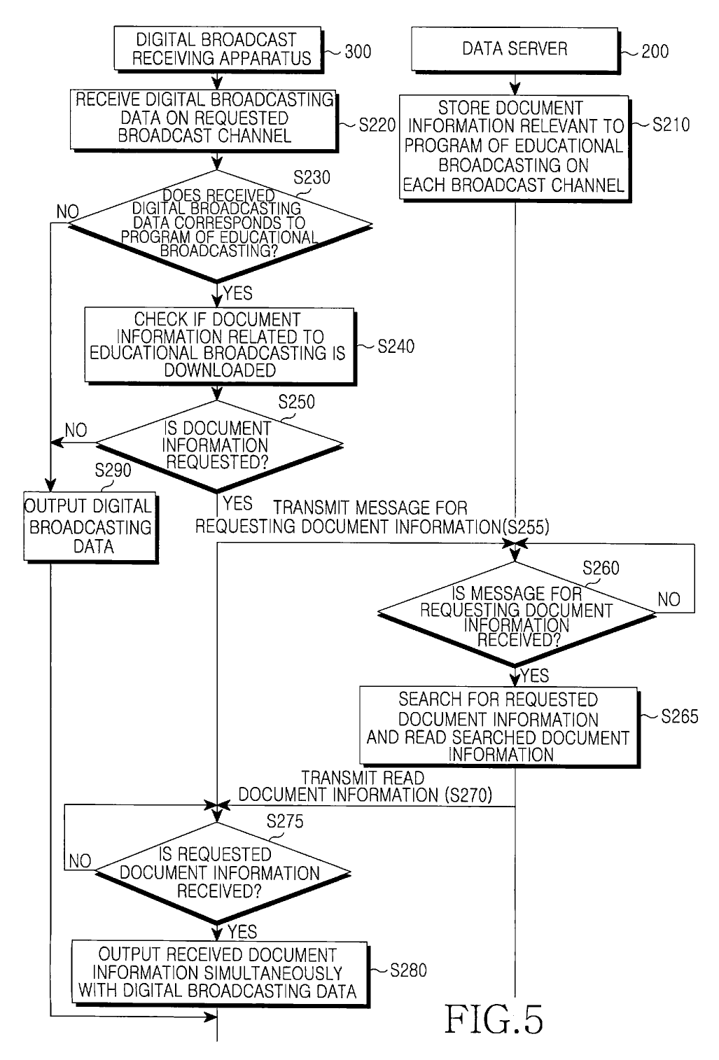

FIG. 5 is a flow diagram illustrating a procedure of a method for providing a digital broadcasting service in a digital broadcasting system according to a second preferred embodiment of the present invention.

With reference to FIGS. 1 to 5, in step 210, the data server 200 stores document information (e.g., the document material such as material for a lecture, material for linguistic learning, etc.) related to a program of educational broadcasting on each broadcast channel after classifying the document information according to a PID of the relevant digital broadcasting data.

In step 229, the digital broadcast receiving apparatus 300 receives the digital broadcasting data on a broadcast channel requested by a user from the broadcasting station. The digital broadcasting data can be either video broadcasting outputting a combination of an image and an audio or audio broadcasting outputting only an audio.

In step 230, the digital broadcast receiving apparatus 300 checks if the received digital broadcasting data corresponds to a program of educational broadcasting. The digital broadcast receiving apparatus 300 checks out channel information or a PID of the received digital broadcasting data, and can determine if the digital broadcasting data is a program of educational broadcasting.

When the digital broadcast receiving apparatus 300 wants to check with the PID if the digital broadcasting data is a program of educational broadcasting, the digital broadcast receiving apparatus 300 checks the PID included in the relevant digital broadcasting data, and can determine if the digital broadcasting data is a program of educational broadcasting.

In addition, where the digital broadcast receiving apparatus 300 wants to check from the channel information if the digital broadcasting data is a program of educational broadcasting, the digital broadcast receiving apparatus 300 identifies SDT information including information indicating the name of channel, USL information on channel, the type of channel, etc. among information configuring the EPGD of the digital broadcasting, which has been previously stored, and can determine if the digital broadcasting data is a program of educational broadcasting.

As a result of the above, if the received digital broadcasting data is a program of educational broadcasting, in step 240, then the digital broadcast receiving apparatus 300 checks if the digital broadcast receiving apparatus 300 has downloaded the document information relevant to the digital broadcasting. So as to check if the relevant document information is to be downloaded, it is desirable that the digital broadcast receiving apparatus 300 shows a message relevant to the above checking on a screen of the display unit 360.

In step 250, the digital broadcast receiving apparatus 300 checks if there exists a request for the document information. If a key is pressed by the user who views out the download confirming message shown by display unit 360, the digital broadcast receiving apparatus 300 can determine that pressing the key corresponds to the request for the document information.

In step 290, if there exists no request for the document information, the digital broadcast receiving apparatus 300 outputs the received digital broadcasting data via the output unit.

In step 255, if there exists the request for the document information, the digital broadcast receiving apparatus 300 generates a message for requesting the document information to transmit the message to the data server 200. The message includes the PID of the pertinent digital broadcasting data.

In step 260, the data server 200 checks if a message for requesting the document information is received from the digital broadcast receiving apparatus 300.

In step 265, if the message for requesting the document information is received from the digital broadcast receiving apparatus 300, the data server 200 searches previously stored document information of each broadcast channel for the requested document information to read the searched document information. Here, the data server 200 detects the PID included in the message, searches for the document information having the same PID as the detected PID, and reads the searched document information.

In step 270, the data server 200 transmits the read document information to the digital broadcast receiving apparatus 300 on data network. On the other hand, if the above search results in the nonexistence of the document information having the same PID as the detected PD, then the data server 200 can transmit a message informing the user of the nonexistence of the document information. On receiving the message, the digital broadcast receiving apparatus 300 outputs the message to inform the user of the nonexistence of the requested document information.

In step 275, the digital broadcast receiving apparatus 300 checks if the requested document information is received.

In step 280, if the requested document information is received, the digital broadcast receiving apparatus 300 outputs the received document information along with the digital broadcasting data. Specifically, the digital broadcast receiving apparatus 300 displays the received document information in a prescribed position on an output screen of digital broadcasting in a PIP format, as illustrated in FIG. 6. Consequently, whenever a predetermined key (e.g., an arrow key) is pressed, the digital broadcast receiving apparatus 300 controls the output unit to scroll a current display of the document information on a screen of the output unit, and can show a scrolled display thereof in place of the current display thereof.

Thus, where the digital broadcasting data received from the broadcasting station 100 corresponds to a program of audio broadcasting (e.g., linguistic broadcasting), the digital broadcast receiving apparatus 300 shows the document information on an overall output screen of the digital broadcasting.

As described above, the user can view with a data service the document information (i.e., material for a place or for a historical background related to broadcasting) pertinent to the program of digital broadcasting while viewing the digital broadcasting, which causes the user's convenience to increase.

Moreover, it is not necessary for the user to personally prepare material for a lecture or for linguistic learning, etc. for learning during the viewing of educational broadcasting or linguistic broadcasting. Hence, the viewer (i.e., the user) can watch a program of educational or linguistic broadcasting simultaneously with the material for a lecture or for linguistic learning on a single screen of the display unit. As a result, the users can acquire rapid progress with their learning.

In addition, energizing the usage of data services helps the profitability of common carriers.

While the invention has been shown and described with reference to a certain preferred embodiment thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

What is claimed is:

1. A digital broadcasting system, comprising:
a broadcasting station for transmitting digital broadcasting data on each broadcast channel;
a data server for storing document information corresponding to the digital broadcasting data on each broadcast channel, for searching for requested document information if there exists a request for document information corresponding to prescribed digital broadcasting data, and for transmitting the requested document information; and
a digital broadcast receiving apparatus for requesting the data server to transmit the document information corresponding to the digital broadcasting data received from the broadcasting station, and for outputting the corresponding document information simultaneously with the digital broadcasting data if the corresponding document information is received from the data server in reply to the request.

2. The digital broadcasting system as claimed in claim 1, wherein the data server transmits the requested document information via a data network.

3. The digital broadcasting system as claimed in claim 2, wherein the requested document information corresponds to document data related to a program of digital broadcasting.

4. The digital broadcasting system as claimed in claim 1, wherein the digital broadcast receiving apparatus determines if the document information has been downloaded corresponding to the digital broadcasting data on receiving the digital broadcasting data from the broadcasting station, and requests the data server to transmit the document information if a user makes a request for the document information.

5. The digital broadcasting system as claimed in claim 4, wherein the digital broadcast receiving apparatus transmits to the data server a message for requesting the document information, which includes a packet identifier of the digital broadcasting data, if the user makes request for the document information.

6. The digital broadcasting system as claimed in claim 5, wherein the data server classifies the document information corresponding to the digital broadcasting data on each broadcast channel according to the packet identifier, and stores the classified document information.

7. The digital broadcasting system as claimed in claim 6, wherein the data server searches previously stored document information for document information having the same packet identifier as a packet identifier included in the message if the message for requesting the document information is received from the digital broadcast receiving apparatus, reads the searched document information, and transmits the read document information to the digital broadcast receiving apparatus.

8. The digital broadcasting system as claimed in claim 7, wherein the data server transmits a message reporting the nonexistence of the requested document information to the digital broadcast receiving apparatus if the data server cannot find the requested document information.

9. The digital broadcasting system as claimed in claim 1, wherein the digital broadcast receiving apparatus displays the received document information in a prescribed position on an output screen of digital broadcasting in Picture-In-Picture format.

10. The digital broadcasting system as claimed in claim 9, wherein the digital broadcast receiving apparatus scrolls the currently displayed document information whenever a predetermined key is pressed, and displays the scrolled document information in place of the currently displayed document information.

11. The digital broadcasting system as claimed in claim 1, wherein the digital broadcast receiving apparatus displays the document information on an overall output screen of an output unit if the received digital broadcasting data corresponds to a program of audio broadcasting.

12. The digital broadcasting system as claimed in claim 1, wherein the digital broadcast receiving apparatus determines if document information has been downloaded corresponding to the digital broadcasting data when the digital broadcasting data received from the broadcasting station corresponds to a program of educational broadcasting, and requests the data server to transmit the document information if a user makes a request for the document information.

13. The digital broadcasting system as claimed in claim 1, wherein the broadcasting station comprises the data server.

14. The digital broadcasting system as claimed in claim 1, wherein the data server receives from the broadcasting station the document information corresponding to the digital broadcasting data of each broadcast channel, and stores the received document information.

15. The digital broadcasting system as claimed in claim 1, wherein the data server receives, from an external apparatus for special use, document information corresponding to the digital broadcasting data of each broadcast channel, and stores the received document information.

16. The digital broadcasting system as claimed in claim 15, wherein the data server receives the document information at every preset cycle or whenever the document information changes.

17. An apparatus for receiving a digital broadcast, the apparatus comprising:
a digital broadcast receiving unit for receiving digital broadcast data on a broadcast channel requested by a user;
a wireless transmitting-receiving unit for requesting a data server to transmit document information corresponding to the digital broadcasting data, and for receiving the requested document information, wherein the data server stores document information corresponding to a broadcast program on each broadcast channel;
an output unit for outputting the received document information simultaneously with the digital broadcasting data if the requested document information is received by the wireless transmitting-receiving unit; and
a control unit for controlling an overall operation of the apparatus for receiving a digital broadcast.

18. The apparatus as claimed in claim 17, wherein the wireless transmitting-receiving unit receives the document information via a data network.

19. The apparatus as claimed in claim 18, wherein the document information corresponds to document data related to a program of digital broadcasting.

20. The apparatus as claimed in claim 17, wherein the control unit checks if the digital broadcast receiving unit has downloaded the document information corresponding to the received digital broadcasting data, and controls the apparatus for receiving a digital broadcast to request the data server to transmit the requested document information if a user makes a request for the document information.

21. The apparatus as claimed in claim 20, wherein the control unit controls the apparatus for receiving a digital broadcast to generate a message for requesting the document information, which includes a packet identifier of the digital broadcasting data, if the user makes a request for the document information, and to transmit the generated message to the data server.

22. The apparatus as claimed in claim 17, wherein the control unit controls the apparatus for receiving a digital broadcast to inform the user of the nonexistence of the requested document information if the wireless transmitting-receiving unit receives a message reporting the nonexistence thereof.

23. The apparatus as claimed in claim 17, wherein the control unit controls the apparatus for receiving a digital broadcast to display the received document information in a prescribed position on an output screen of digital broadcasting in a Picture-In-Picture format.

24. The apparatus as claimed in claim 23, wherein the control unit controls the apparatus for receiving a digital broadcast to scroll the currently displayed document information whenever a predetermined key is pressed, and to display the scrolled document information in place of the currently displayed document information.

25. The apparatus as claimed in claim 17, wherein the control unit controls the apparatus for receiving a digital broadcast to display the document information on an overall output screen of the output unit if the received digital broadcasting data corresponds to a program of audio broadcasting.

26. The apparatus as claimed in claim 17, wherein the received digital broadcasting data corresponds to a program of educational broadcasting.

27. A method for providing a digital broadcasting service in a digital broadcast receiving apparatus, the method comprising the steps of:
(1) receiving digital broadcasting data on a broadcast channel requested by a user;
(2) requesting a data server to transmit document information corresponding to the digital broadcasting data, wherein the data server stores document information corresponding to a broadcast program of each broadcast channel; and
(3) outputting the received document information simultaneously with the digital broadcasting data if the requested document information is received from the data server.

28. The method as claimed in claim 27, wherein the document information is received via a data network.

29. The method as claimed in claim 28, wherein the document information corresponds to document data related to a program of digital broadcasting.

30. The method as claimed in claim 27, wherein step (2) comprises:
(2-1) determining if the document information corresponding to the received digital broadcasting data is downloaded; and
(2-2) requesting the data server to transmit the document information if the user makes a request for the document information.

31. The method as claimed in claim 30, wherein, in step (2-2), a message for requesting the document information is transmitted to the data server if the user makes a request for the document information, wherein the message includes a packet identifier of the digital broadcasting data.

32. The method as claimed in claim 27, further comprising informing the user of the nonexistence of the requested document information if a message reporting the nonexistence thereof is received from the data server.

33. The method as claimed in claim 27, wherein, in step (3), the received document information is displayed in a prescribed position on an output screen of digital broadcasting in Picture-In-Picture format.

34. The method as claimed in claim 33, wherein, in step (3), the currently displayed document information is scrolled whenever a predetermined key is pressed, and the scrolled document information is displayed in place of the currently displayed document information.

35. The method as claimed in claim 27, wherein, in step (3), the document information is displayed on an overall output screen of an output unit if the received digital broadcasting data corresponds to a program of audio broadcasting.

36. The method as claimed in claim 27, wherein the received digital broadcasting data corresponds to a program of educational broadcasting.
